(19) United States
(12) Patent Application Publication
(10) Pub. No.: US 2008/0043089 A1
(43) Pub. Date: Feb. 21, 2008

(54) REAL TIME INTERACTIVE ENTERTAINMENT

(76) Inventors: Philip AUERBACH, New York, NY (US); Michael Barasch, New York, NY (US)

Correspondence Address: KALOW & SPRINGUT LLP, 488 MADISON AVENUE, 19TH FLOOR, NEW YORK, NY, 10022, US

(21) Appl. No.: 11/763,613

(22) Filed: Jun. 15, 2007

Related U.S. Application Data
(60) Provisional application No. 60/814,407, filed on Jun. 16, 2006.

(51) Int. Cl. H04N 7/14

(52) U.S. Cl. 348/14.1; 348/192; 348/153; 348/156; 348/149

(57) ABSTRACT

Sports fans enjoy sporting activities more when they can feel connected to the participants. Through a method of increasing communications between athletes, their fans and commentators, sports fans can feel a greater connection to the athletes whom they are watching and thereby obtain a greater degree of enjoyment from watching the event. Further, by watching the athletes being instructed on how to improve their games, the fans can also learn how to improve their own skill sets.

### CROSS-REFERENCE TO RELATED APPLICATION

This application claims the benefit of the filing date of U.S. Provisional Application Ser. No. 60/814,407, filed Jun. 16, 2006, the entire disclosure of which is incorporated by reference as if set forth fully herein.

### FIELD OF THE INVENTION

The present invention relates to entertainment through real time broadcasting of sporting events.

### BACKGROUND OF THE INVENTION

Sports fans have always enjoyed watching sporting competitions, and many sports fans pride themselves on being amateur athletes. Traditionally, fans of sporting events have gone to events and watched passively from the stands; watched the events on television or over the Internet; and/or listened over the radio. However, for at least two reasons, remote fans, i.e., those fans who view an event on television or over the Internet or listen over the radio, find their remote attendance of these events to be unsatisfactory.

First, remote fans feel isolated from other fans. Remote fans often view the events from the comfort of their homes, while listening to commentary from professional sportscasters. They also often watch or listen to the events alone or in the company of only a few other persons. Thus, the typical remote fan has no access to the sportscaster other than by being a passive listener or to more than a few other remote fans with whom to share the experience.

Second, remote fans feel disconnected from the athletes. Although remote fans are privy to the commentary from the sportscasters, the athletes have little or no access to this commentary. Thus, the fans are not able to enjoy witnessing the professional athletes' responses, to the commentary.

The present invention addresses these issues by providing methods and systems for real time interactive sports entertainment.

### SUMMARY OF THE INVENTION

The present invention is directed to entertainment through the broadcasting of real time interactive sports programming. According to one embodiment, the present invention is directed to a method of entertaining, said method comprising:
a. generating a first video, wherein said first video comprises images of at least one participant engaging in a first activity;
b. broadcasting said first video to an audience, wherein said audience comprises at least one person who is located remote from said participant and said broadcasting occurs substantially contemporaneously with said generating said first video;
c. providing commentary to said audience and to said at least one participant, wherein said providing occurs substantially contemporaneously with said broadcasting said first video;
d. generating images of said at least one participant receiving said commentary; and
e. broadcasting said images of said at least one participant receiving said commentary to said audience.
   Optionally, the audience member can provide feedback to the person or entity broadcasting the video with commentary. Through use of the method of the present invention, remote users can feel more connected to athletes who they watch, as well as to other remote audience members and thereby increase their viewing satisfaction.

### BRIEF DESCRIPTION OF THE FIGURE

FIG. 1 is a flowchart that represents certain steps of one embodiment of the present invention.

### DETAILED DESCRIPTION OF THE INVENTION

The present invention will now be described in connection with preferred embodiments. These embodiments are presented to aid in an understanding of the present invention and are not intended, and should not be construed to limit the invention in any way. All alternatives, modifications and equivalents that may become apparent to those of ordinary skill upon reading this disclosure are included within the spirit and scope of the present invention. Further, the present disclosure is not intended to be a treatise on any particular sport or broadcasting technology.

According to a first embodiment, the present invention is directed to a method of entertaining through the creation of a real time interactive sporting event experience. Under this method, one generates a first video. The first video comprises images of a least one participant engaging in a first activity. The first video is a collection of images and preferably sounds in any media suitable for real time transmission, e.g., analog or digital media. The first video may be obtained from one camera or from a plurality of cameras, e.g., two, three, four, five, etc. Although multiple images from different angles may be recorded, all images that are collected and subsequently broadcast during this time are collectively part of the “first video.” If multiple cameras are used, a person either at the location that the video is being shot or remote from that location could direct which camera should send the live feed for broadcasting to audience members as described below. For example, from a studio the person may watch all videos being shot, and direct which view will be broadcast.

As persons skilled in the art are aware, video cameras, including both analog and digital cameras record images and as is common in the television industry, send the images to broadcast stations. In connection with transmission of these images, a Codec may be used, which is a device or a program that has the ability to code and decode a stream of data. (Codecs may encode a stream or signal.) The encoded information may be transmitted, stored, or encrypted and decoded for viewing or editing.

In some embodiments, a video camera's analog to digital converter or encoder may convert its analog signals into digital signals (e.g., MPEG-2), which are then passed through a video compressor for digital transmission. Next a receiving device may run the signal through a video decompressor and then a digital to analog converter for analog display. An audio compressor may be used to convert analog audio signals into digital signals for transmission. A receiving device may then be used to convert the digital signals back to analog using, e.g., an audio decompressor, for playback. Further, audio and visual content may be organized in a container format.

Although the images are captured in a form suitable for real time transmission, they may optionally also simultaneously be recorded as is common with most professional sporting events that are broadcast live, e.g. events sponsored by MLB, NFL, NBA, WNBA, the Olympics and PGA. These simultaneous recordings can then be used at a later time for, e.g., re-broadcast. Persons skilled in the art are familiar with the technologies for implementing these real time or live broadcasts and simultaneous recording technologies.

The phrase “real time” as used herein refers to a broadcast or transmission that occurs substantially at the same time that an event occurs and is available over a network or through a broadcast at the same time to all audience members. Of course the time is delayed by the small amount of time necessary for images to be captured, processed and transmitted, and the phrase is meant to encompass this time period as well. Further, real time broadcasts can also include short time delays, e.g., up to ten minutes, and preferably less than five minutes as are being implemented by some organizations in order to allow for removal of undesirable content. However, preferably no such delay or essentially no delay (i.e., less than 1 minute) is used.

The at least one participant may for example be one or more amateur, semi-professional or professional athlete(s) who is (are) engaged in an activity, e.g., golf, tennis, gymnastics, figure skating, baseball, football, basketball, soccer, hockey, swimming, diving, skiing, dancing, etc. In some embodiments the at least one participant may comprise a plurality of participants, e.g., two, three, four, five, six, seven, eight, nine, ten, eleven, twelve, etc. For example, the plurality of participants may comprise two, three or four (or more) persons playing a round of golf or a game of tennis. The plurality of participants may alternatively comprise teams engaged in competitive activities such as baseball, basketball, hockey, soccer, football, etc. The activity may be in the context of a sports competition, e.g., a golf tour, or the activity may be in the context of a skill improvement set, e.g., an individual participant on a golf course or in a skating rink or at a batting cage.

The images of the first video may be broadcast in real time to an audience. Preferably the first video comprises images that have been relayed to a studio or other facility for collecting the video and making it accessible to a wide audience. As noted above, a video camera or webcam (or plurality of these devices) may be used to capture the images that form the first video. These images (and accompanying audio) may, for example, be uploaded to a computer for processing and transmission, e.g., conversion from analog to digital format if not first otherwise captured in digital format, compression and encryption of the video data for transmission to the studio. These images may e.g., be transmitted over the Internet to the studio. Alternatively, they may be transmitted via a satellite or other means for transmitting real time video images that are now known or that come to be known and that would be appreciated by one skilled in the art as useful in connection with the present invention.

The studio may be located proximal to the site of the activity, e.g., in a clubhouse at a golf course, or in a broadcast booth at a stadium. Although the live activity may be visible from the studio, it is not necessary for the live activity to be visible from the studio. Thus, the studio may also be remote from the location of the activity. For example, the studio may be located at a television network's headquarters. The benefit of having the studio remote from the location of the activity is one of economics, there is no need to create a new studio for each new location. If for example, multiple participants were playing golf at different locations (as opposed to the same or different holes of the same golf course), videos from these different sites could be relayed to the same studio and then broadcast from that studio. Accordingly competitors or charity events could e.g., be coordinated on different golf courses.

From the studio, the first video is broadcast to the audience. Broadcasting may be over the airwaves, cable, satellite or any other signal transmission media, using transmitter towers, communication satellite systems, and cable distribution networks. Preferably, the broadcasting occurs as a continuous feed in substantially real time. Thus, as the activity is occurring, the images (and accompanying audio) are being relayed to the studio and then broadcast to the audience. The audience may comprise one or more persons. Preferably, the audience comprises a plurality of persons, e.g., more than 50, more preferably more than 100, more preferably more than 1000, more preferably more than 10,000, more preferably more than 100,000 and most preferably more than 1,000,000. Although the video is broadcast in real time, within the scope and spirit of the present invention is contemplated that the first video may be interrupted to provide for the broadcasting of commercials.

Audience members may receive the broadcast through any system that is capable of converting a broadcast output signal into human perceptible form. For example, the first video may be broadcast through traditional channels for broadcasting as is done by the television industry or over the Internet, e.g., via a telecommunications link such as a telephone line, a cable line or a wireless connection. The Internet may, for example, be accessed through home computers and cellular telephones. Preferably any device that accesses the Internet will be able to output both audio and video content.

As is known in the art, the Internet includes providers such as Internet access providers and network service providers and routers that provide wired and wireless digital communications throughout the world using TCP/IP networking protocol. Computers may access the Internet directly or be operatively connected to a local area network (LAN) over which information is transmitted to other computers on the same LAN or to computers on other LANs through a localized Intranet. The information can be transmitted between the user and the Internet via the Intranet.

The system may be designed for free access over the Internet through for example an unrestricted URL site. Alternatively, access to the site may be limited to fee paying subscribers by, for example, the requirement of the use of passwords.

The audience members may also receive the entertainment through their televisions (e.g., cable television or UHF/VHF broadcasts) through either free broadcasts or fee for services technologies. Further, preferably individual users have the choice of accessing the video through the Internet or over through their televisions. Sporting events have been watched on television for decades, and the technologies employed by for example, MLB, the NFL, the NBA, the WNBA, etc. for broadcasting live events are well known to persons of ordinary skill in the art.

The at least one audience member is preferably remote from the participant. Thus, preferably the at least one audience member is not simultaneously able to view the activity in person. However, as the remote audience member views the broadcast, fans who are witnessing the event live may, e.g., through their personal wireless devices such as cellular telephones, if equipped with video display capabilities, view the broadcast as well.

As the first video is being broadcast, preferably at least one commentator provides a substantially contemporaneous commentary on the at least one participant's activity. The phrase “substantially contemporaneously” is used to refer to commentary that is provided in real time. Preferably, the commentary is audio and/or appears as closed-captioned text for viewing. Optionally, the image of the at least one commentator will appear as a video that is next to or on top of the first video in order to allow the audience to view the at least one commentator at the same time that the audience views the participant engaging in the activity. The commentary may, for example, in the context of golf relate to the participant's posture, stance, grip, tempo and/or swing plane.

Integrating commentary with live broadcasts has been done for decades by MLB, the NFL, the NBA, etc. and technologies for integrating these commentaries are also well known. More recently with the advent of broadcasts over the Internet, new technologies have been developed for providing commentaries, including but not limited to technologies associated with RNS (remote navigation streams), e.g., example as described in U.S. Pat. No. 7.035,531, Device and Methodfor Supplying Commentary Information, Apr. 25, 2006.

As the commentary is broadcast to the at least one audience member, preferably it is also broadcast to the at least one participant. Thus, both the participant and the audience receive the commentary at the same time or at substantially the same time. The commentary may be video transmitted to the at least one participant or an audio only transmission system, e.g., radio waves or to a cellular telephone that does not have the capability to receive video transmissions or to any other device that allows for the receipt of audio transmissions, e.g., a Bluetooth earpiece. Preferably, the device is capable of being affixed in or in the proximity of the participant's ear (or a plurality of participants' ears). Thus, for example, a professional athlete may have an earpiece that permits her while playing golf, figure skating, playing tennis, skiing, dancing, etc. to hear the commentary at the same time (or at least substantially the same time) that the audience hears it. When multiple athletes are the subjects of the broadcasts, the broadcaster (who may or may not be the same person providing commentary) may choose to equip one, a plurality on all of the athletes with earpieces.

Alternatively, the participant could have access to a site that is equipped with audio-video receiving capabilities, e.g., a television or Internet access through, for example a cellular telephone with video capability or a readily visible personal or network computer. Thus, for example, an athlete may be able to view the video of herself and to hear the commentary at the same time that the audience hears it.

As the participant hears the commentary, the first video continues being generated. Thus, video images are generated that comprise images of said at least one participant receiving and reacting to said commentary.

These images of the at least one participant hearing the feedback are, as part of the real time broadcast, broadcast to the audience. Thus, the audience may enjoy watching the response of the participant to the commentary. Because the commentary may be constructive, the audience may watch a participant try to improve his or her skills by following the advice of the commentator. Alternatively, the at least one participant may voice disagreement with the commentator.

When two or more participants play and engage in the same activity but at different times and/or different locations, the video of the first participant may be referred to as the “first video” while the video of the second participant may be referred to as the “second video.” For example, a first golfer may be at hole one of the golf course while a second golfer is located at hole two of the golf course or on a different golf course altogether. They may be golfing at the same or different times. In this case, the first video is the video that records the activities of the first golfer and the second video records the activities of the second golfer.

By way of another example, two persons may be engaged in a tennis match. As persons familiar with tennis are aware, the ball travels back and forth over the net, and the first tennis player is at one end of the court, while the second tennis player is at the other end of the court. In this case, a first camera will capture the images of the first tennis player while a second camera will capture the images of the second tennis player. These images may be shown in succession or simultaneously in split screen format e.g., images of a plurality of participants that appear side by side when viewed even if the participants are not actually filmed by the same camera. Similarly, a plurality of images of the same person from e.g., different angles may be shown in split screen format.

As the videos are being broadcast, viewers may become further involved by providing feedback to the commentator. This viewer feedback may for example, be provided over telephone landlines, cellular telephone networks through text messages or oral communications, or through the Internet, through e.g., web-cams, email and instant messaging. In order to facilitate real time viewer feedback, the broadcast may contain information on how to contact the commentator, including through hyperlinks, e-mail addresses or telephone call-in numbers. Further, real time chat rooms may be established so that viewers may communicate in real time not only with the commentators, but also with other audience members.

A commentator may, after reviewing the feedback, choose to incorporate it into the broadcast. For example, an e-mail or text message could be read or a call-in viewer could speak on the air. The participant's reaction to the audience member's feedback may then also be broadcast.

According to one preferred embodiment the first video can be interrupted by the broadcasting of an archived video clip. An “archived video” is a video that recorded a previous activity, for example, an activity that took place earlier that day, or in the preceding days, weeks, months or years i.e. is a second activity. In some embodiments, the archived video contains images and audio of the same participant as on the first video. The archived video may also contain commentary reflecting not only the video as recorded, but also as broadcast. When an archived video clip is retrieved, it may e.g., be in the form of a pre-encoded MPEG stream. The pre-encoded MPEG stream may enter the broadcast from a dedicated playout system e.g., a personal computer or workstation that has a large high-speed disk array and a plurality of digital interfaces that allow for transmission of data to the rest of the transmission system.

The access of archived video clips is typically done through the scanning of a database for a unique identifier of a desired clip. For example, the identification unit could comprise a unique numerical code and/or incorporate the date of the clip and/or name of the subject of the clip. In one embodiment the archived clips that are accessed would be accessed by the broadcaster or person located at or associated with the studio. When accessing archived clips, one may use any system that is now known or that comes to be known and that a person of ordinary skill would appreciate as being useful in connection with the present invention, e.g., storage and retrieval means. Audio and video may be stored together or separately by a microprocessor. Examples of storage media include but are not limited to laser video discs, CD-ROM compact discs and RAM hard drives when storage is digital, one may choose compression techniques.

Systems in which audience members, including those accessing the broadcast via the Internet, access the archived clips directly for their own personal viewing are also within the scope of the present invention. In these scenarios, the audience member would need access to the database of archived videos, or in the alternative could access a different database, e.g., a personal database or remote database not affiliated with the broadcaster.

By introducing the archived video clip, the viewer may for example, be provided with images of how the participant's activities are the same or different as his or her activities on previous attempts. Alternatively, the archived video clip can be of a different athlete, for example, a celebrity, and the participant's actions can be compared to those of the athlete. The audience member could share the video archive with the commentator, by either sending a copy as an e-mail attachment, identifying a hyperlink or describing where it is located, and/or provide feedback that references the archived clip.

The invention may also be used in connection with pod casting, when for example the video of the participant is prerecorded but the subsequent reaction to commentary by the participant is provided in real time.

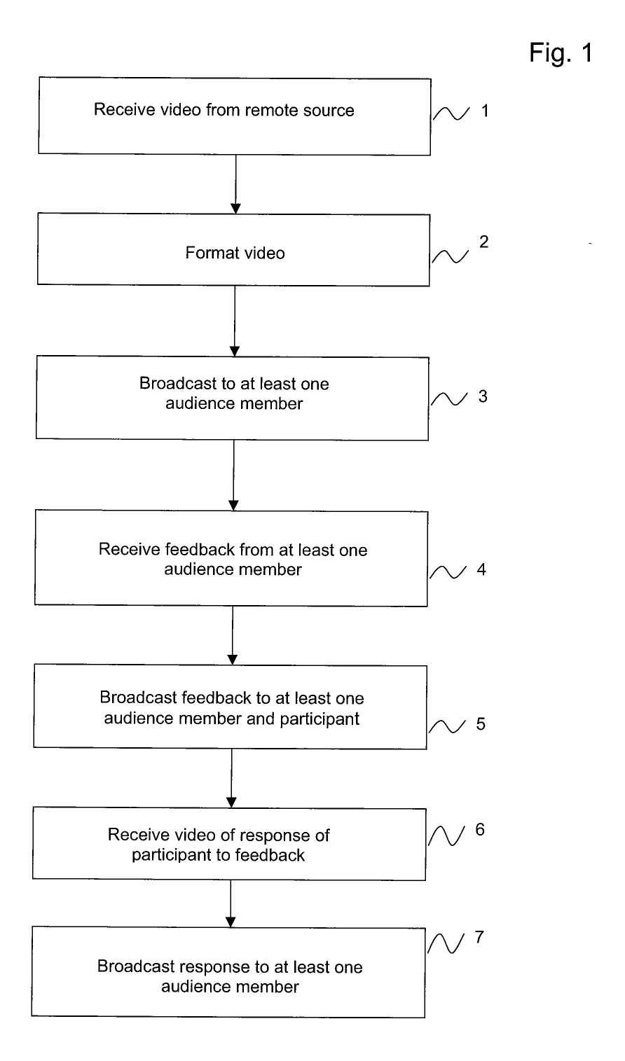

Further understanding of certain embodiments may be provided by referring to FIG. 1. First, a studio or other facility receives video of an event from a remote source 1, e.g., video camera or webcam, located at the proximity of the event, either via transmission over satellite communications, the Internet, or another dedicated wired or wireless link. Second, the video is prepared for broadcast 2. The video may e.g., be modified to fit the technological requirements for broadcast, including but not limited to file size requirement, image size requirement, etc. and/or e.g. have added to it the broadcaster's logos or trademarks, a music soundtrack or other special effects, as well as have time stamping added to it. Third, the formatted video along with real time commentary is broadcast to at least one audience member 3. It may be broadcast over the air as with a radio station or TV station to an antenna and receiver, or may be broadcast through cable TV or wireless cable via the station or directly from a network. The video may also be broadcast over the Internet, with multicasting allowing the signal and bandwidth to be shared. Broadcast video may also be transmitted via communications satellite. Fourth, the commentator may receive feedback from at least one broadcast audience member 4, via e.g., telephone calls, SMS messages, emails, web cam videos, or any other means of communication via any type of wired or wireless communication link. Fifth, at the discretion of the commentator and broadcasting studio or facility, specific feedback may be broadcast to at least one audience member and the participant 5 using the same broadcast methods as used for said video. Sixth, the studio or other facility receives video of the reaction or response of said participant to the audience feedback 6, which is then broadcast to at least one audience member 7 possibly for additional audience feedback.

Although the invention has been described and has been illustrated in connection with certain specific or preferred inventive embodiments, it will be understood by those of ordinary skill in the art that the invention is capable of many further modifications. This application is intended to cover any and all variations, uses, or adaptations of the invention that follow, in general, the principles of the invention and include departures from the disclosure that come within known or customary practice within the art and as may be applied to the essential features described in this application and in the scope of the appended claims.

What is claimed:

1. A method of entertaining, said method comprising:
a. generating a first video, wherein said first video comprises images of at least one participant engaging in a first activity;
b. broadcasting said first video to an audience, wherein said audience comprises at least one person who is located remote from said participant and said broadcasting occurs substantially contemporaneously with said generating said first video;
c. providing commentary to said audience and to said at least one participant, wherein said providing occurs substantially contemporaneously with said broadcasting said first video;
d. generating images of said at least one participant receiving said commentary; and
e. broadcasting said images of said at least one participant receiving said commentary to said audience.

2. The method according to claim 1, wherein said first activity is at least one activity selected from the group consisting of golf, tennis, gymnastics, figure skating, baseball, football, basketball, soccer, hockey, swimming, skiing, dancing and diving.

3. The method according to claim 1, wherein said generating said first video comprises filming with a plurality of cameras.

4. The method according to claim 1, wherein said broadcasting said first video is over the Internet.

5. The method according to claim 1 further comprising broadcasting an archived video clip wherein said archived video clip comprises images of said at least one participant engaging in a second activity.

6. The method according to claim 5, wherein said first activity and said second activity both comprise golf.

7. The method according to claim 1, wherein said commentary comprises instructions on how to improve at said first activity.

8. The method according to claim 1 further comprising receiving audience feedback, wherein said audience feedback comprises responses to said commentary.

9. The method according to claim 8 wherein said audience feedback is transmitted over the Internet.

10. The method according to claim 8, wherein said audience feedback is transmitted to said at least one participant.

11. The method according to claim 1, wherein said broadcasting said first video comprises broadcasting images that form a split screen for said audience.
